(19) United States
(12) Patent Application Publication
(10) Pub. No.: US 2017/0115841 A1
(43) Pub. Date: Apr. 27, 2017

(54) Reading State - A method for repositioning reading material on electronic devices

(71) Applicant: Khozem Z. Dohadwala, Naperville, IL (US)

(72) Inventor: Khozem Z. Dohadwala, Naperville, IL (US)

(21) Appl. No.: 14/922,168

(22) Filed: Oct. 25, 2015

(51) Int. Cl. G06F 3/0485; G06F 3/0488; G06F 3/0484

(52) U.S. Cl. CPC G06F 3/0485; G06F 3/04845; G06F 3/04883

(57) ABSTRACT

Reading State, a method to allow repositioning of reading material on electronic devices. While the reading activity is in progress, the software control tracks the activity and displays the state through a visual element. The control associates the reading state information with the article being read and persists it on the electronic device's storage when the reading activity is interrupted. On reading of the same article on the same device, the control displays the prior reading state using an inverted thermometer like visual element and a tap on the visual element repositions the article to the prior read state so the person can continue reading from where they left off the last time.

### BACKGROUND

Due to common use of electronic devices like smartphones, tablets, PC, Macs and extensive number of applications (apps) providing access to reading material on these devices, people read a lot on these devices. Reading material could be blogs, newspaper articles, emails, documents, notes etc. (an article). Quite a few times the article being read is not read fully, this is due to other interruptions provided by these devices or the high chance of interruptions where reading material is lengthy. When the person reading an article has not finished reading it completely and gets back to reading that article, it usually it takes some effort to remember how far the article had been read the first time and some time is spent on scrolling till the person finds the spot from where the reading can commence again.

The proposed design solves the issue of remembering how far someone had read an article and positioning the article very closely to the point at which it was read before, hence providing continuity and a quick way to continue reading incompletely read articles.

### BRIEF SUMMARY OF THE INVENTION

A software control maintains information for the reading state of an article on a device. This control also implements persisting and retrieving of the reading state associated with the article. This control also has a simple visual element like an inverted thermometer that will display the reading state, illustrated in FIG. 1.

The control will maintain the reading state by tracking the amount of article actually read and persist this information when the person switches to another activity on the device. When the person starts reading the same article again on the same device, the control will display the prior reading state using the visual representation shown in FIG. 1. Tapping on the control will cause the control to scroll the article to the approximate position that the reading state indicates. This will permit the person to continue reading the article right from where they had left off the last time it was read.

There are quite a few applications available on electronic devices for reading. Newspaper apps, browsers, content aggregator, blog websites and apps etc. are some examples of apps proving reading functionality (Reader apps). These reader apps provide an area where controls for various actions are provided. The Reading State control can be very suitably placed in that area. FIG. 2 shows an example of how that placement could work.

### BRIEF DESCRIPTION OF THE DRAWINGS

FIG. 1—Visual Representation of Reading State—Inverted Thermometer.

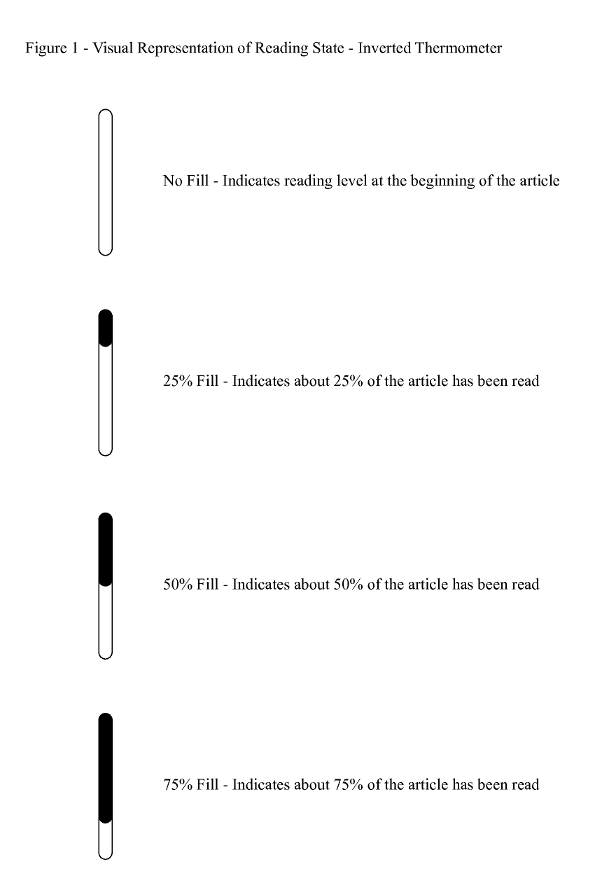

FIG. 2—Integrating Reading State control with reader apps on electronic devices.

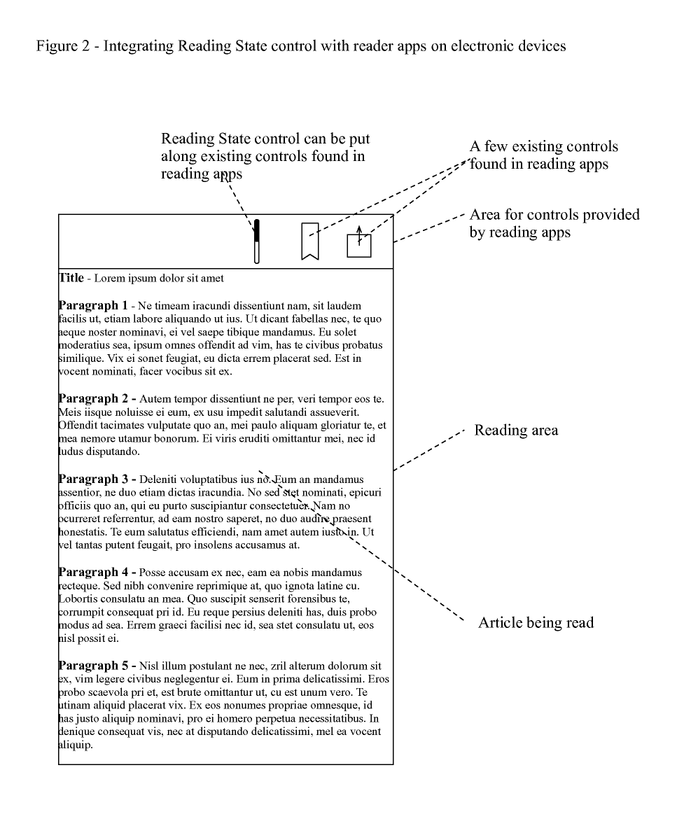

FIG. 3—Reading State control tracking extent of reading done on an article—sample 1.

FIG. 4—Reading State control tracking extent of reading done on an article—sample 2.

FIG. 5—Sample articles and determination of the reading state information.

FIG. 6—Reading State control repositioning previously half read article.

FIG. 7—Process Flow for Reading State control.

### DETAILED DESCRIPTION AND BEST MODE OF IMPLEMENTATION

The Reading State control has to solve three essential issues for providing the functionality to track the reading state and to reposition the article where the reading was left off earlier.

1—Determine the extent of reading done on the article,

2—Persist the reading state of the article when the reading activity is interrupted

3—Obtain the persisted reading state to display the prior extent of reading and allow repositioning of that article to prior read position.

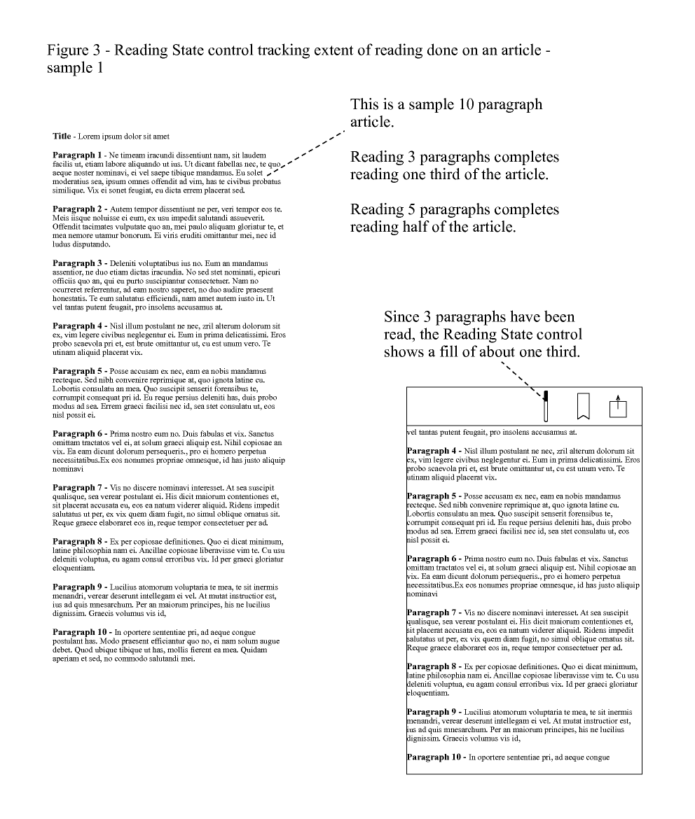

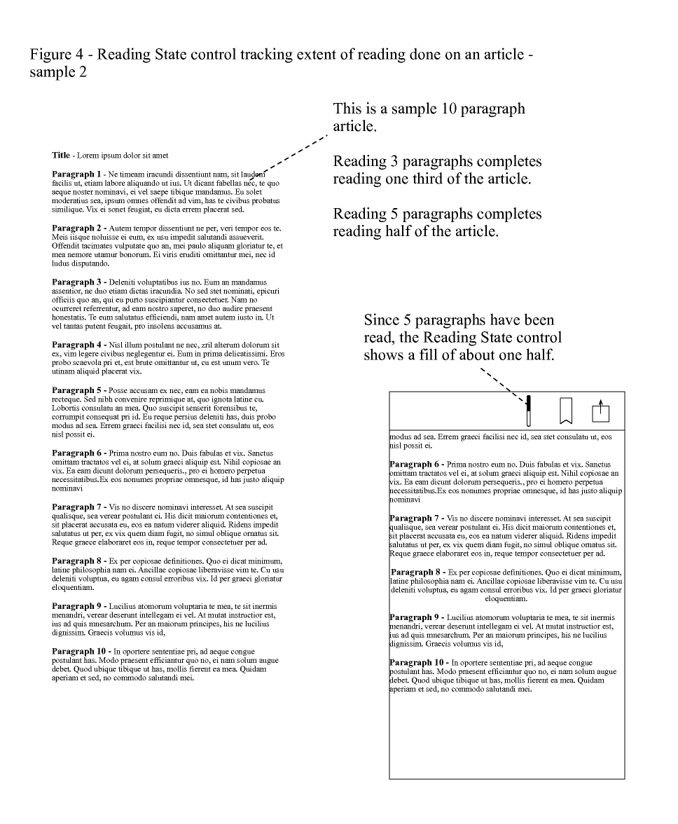

The reader apps format articles for reading based on the screen area available for display and amount of that space required for other uses. A given article could be formatted differently on different devices and would require a specific amount of forward scrolling to read completely. The extent of forward and backward scrolling performed when reading an article can be directly used to determine the extent of reading of the article. For example, if fully reading an article on an electronic device with a specific reader app will require scrolling forward through the full length of the reading area of the device 10 times, then a scrolling forward of 5 lengths of the reading area of the device indicates the person has read the article halfway. FIGS. 3 and 4 provide sample illustration of how the reading state displayed by the control changes as the reading progresses.

Incorporating the time delay between two subsequent scrolling actions and combining it with the amount of scrolling done can be used to determine the extent of the reading more precisely. Let's say a person is reading an article that required 10 full scrolling forward actions to complete. Say the person scrolls about half the full forward scroll length every 20 seconds. After scrolling forward and reading for about 50 seconds, the person switches from reading the article to doing something else on the device. We can use this information to better position the article when the person reads it the next time as we know that the person has completed 2 half lengths of scrolling already and must have completed reading through an additional ¼th length of the reading area, so the Reading State control should position the article at approximately 1 and ¼^{th} full length of the article.

Most programming languages to create apps for electronic devices based on prominent operating systems like iOS, Android, Windows and OS X provide Application Programming Interface (API) to programmatically obtain forward and backward scrolling events and timers to allow the Reading State control to accomplish tracking the reading state very precisely.

The activity of reading of the article can be interrupted in various ways. The person reading the article might decide to navigate to another article in the same reader app or they might close this app and open up another app to perform some other activity or the device might be switched off or powered down. The Reading State control will implement code based on specific API features available for the hardware/operating system of the electronic device to obtain events corresponding to these interruptions and persist the reading state for the article on the electronic device.

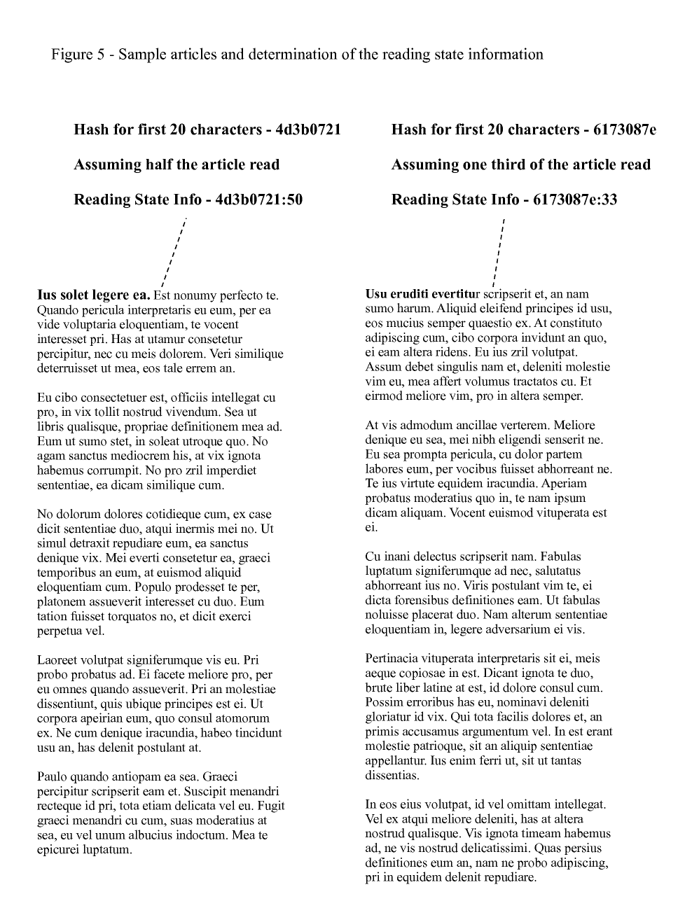

A reading state has to be associated to the specific article being read. The requirement is to uniquely identify the article and a number that represents the amount of article already read. This information can take the form of a set of two numbers like articleIdentifier:amountRead. A simple, computationally efficient hash (e.g. Adler32 hash) of the first N characters of the article can represent the articleIdentifter. The value of N can be determined by performing some analysis across a number of few different types of articles, to determine an optimal maximum value of N to generate a unique hash value most of the time, considering also the computation efficiency. The amountRead number will be between 0 and 100, with 0 indicating that the article has just begun to be read. FIG. 5 illustrates a few examples of determining reading state information. The programming language APIs provide features to store application related data to the permanent storage of the electronic devices, these API features can be used to store the reading state information.

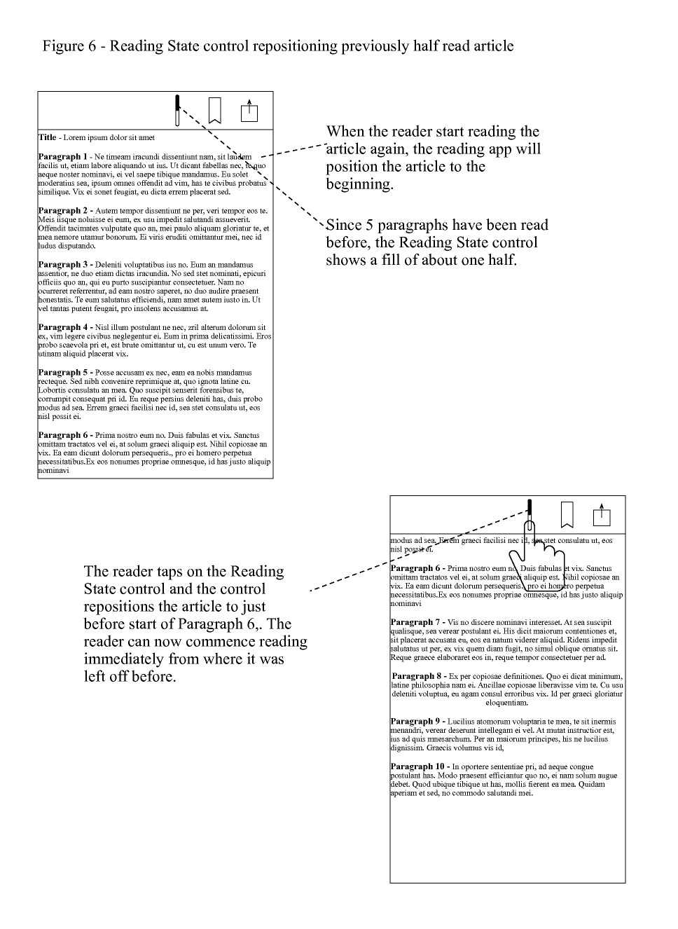

The persisted reading state information can be read and be used by the control to display the extent of the prior reading of the article. Once the person starts reading the same article again on the same device, the control will recalculate the hash of first N characters of the article and retrieve the reading state information from the device. It will render the state of the reading on the visual element appropriately. When the person taps on the visual element, then control will use the scrolling features provided by the API to position the article appropriately on the display so the person can continue reading from where they left off. FIG. 6 illustrates the reposition of the article when the visual element of the control is tapped.

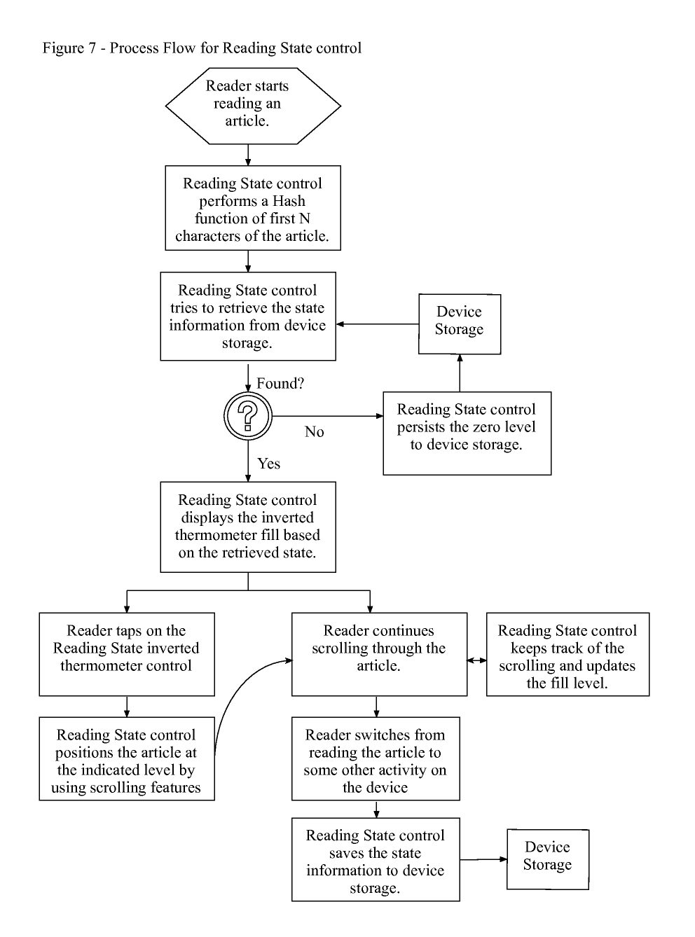

FIG. 7 shows the process flow of the control during the entire reading activity. There will be some other user interaction patterns that the control will have to provide for. Lets say the person does not tap on the visual element of the control to reposition the article, but continues to scroll through the article again. In this case, the control can discard the prior state information and start again. Another approach would be to let the control keep on displaying the prior read state and then start updating the read state once the person scrolls past the prior state. Both these approaches are suitable approaches and the use of one versus another could be either decided during integration of the control with the reader app or could be configurable based on a property provided by the reader app.

What is claimed is:

1- The reading state control that keeps track of the reading state of an article and displays that state through a visual element.

2- The mechanism for associating the reading state information with the article being read and persisting it using API features of the applicable programming languages for the hardware/software development platforms.

3- Ability of the control to reposition the article to the prior read state on tapping of the visual element of the control.
